(19) United States
(12) Patent Application Publication
(10) Pub. No.: US 2010/0029135 A1
(43) Pub. Date: Feb. 4, 2010

(54) Antistatic card connector

(75) Inventor: Nai-Hock Lwee, Singapore (SG)

Correspondence Address: BACON & THOMAS, PLLC, 625 SLATERS LANE, FOURTH FLOOR, ALEXANDRIA, VA, 22314-1176, US

(73) Assignee: TAI-SOL ELECTRONICS CO., LTD., Taipei City (TW)

(21) Appl. No.: 12/232,632

(22) Filed: Sep. 22, 2008

(30) Foreign Application Priority Data
Jul. 29, 2008 (TW) 97213438

(51) Int. Cl. H01R 24/00

(52) U.S. Cl. 439/626

(57) ABSTRACT

An antistatic card connector includes a base frame, a cover shell, a plurality of terminals, and a grounding member. The base frame is made of insulative material. The cover shell is made of electrically conductive material and covered on the base frame. An opening is formed at a front end of the combination of the base frame and the cover shell. At least one card chamber is formed inside the combination of the base frame and the cover shell for receiving an electronic card. The terminals are mounted to the base frame and located inside the card chamber. The grounding member is made of electrically conductive material and located below the opening, extending transversally along a front edge of the base frame. Accordingly, the antistatic card connector can fully avoid the static.

### BACKGROUND OF THE INVENTION

1. Field of the Invention

The present invention relates generally to memory card connectors, and more particularly, to an antistatic card connector.

2. Description of the Related Art

As disclosed in Taiwan Patent No. M273,783, a conventional antistatic card connector includes an electronic frame having an upper frame portion for grounding while an electronic card is inserted into the card connector. By the electronic frame, the static in the electronic card while inserted can be directly conducted for grounding to prevent an external electronic apparatus connected with the electronic card from damage resulted therefrom.

However, such design cannot fully avoid the damage resulted from the static because some distal ends of the terminals are located below the card entrance of the card connector for connection with the circuit board and while the electronic card is inserted, the static of the electronic card itself is still likely conducted to the distal ends of the terminals to damage other electronic components.

### SUMMARY OF THE INVENTION

The primary objective of the present invention is to provide an antistatic card connector, in which both of the upper and lower sides of the card entrance are antistatic.

The foregoing objective of the present invention is attained by the antistatic card connector composed of a base frame, a cover shell, a plurality of terminals, and a grounding member. The base frame is made of insulative material. The cover shell is made of electrically conductive material and covered on the base frame. An opening is formed at a front end of the combination of the base frame and the cover shell. At least one card chamber is formed inside the combination of the base frame and the cover shell for receiving an electronic card. The terminals are mounted to the base frame and located inside the card chamber. The grounding member is made of electrically conductive material and located below the opening, extending transversally along a front edge of the base frame.

### BRIEF DESCRIPTION OF THE DRAWINGS

FIG. 1 is a perspective view of a first preferred embodiment of the present invention.

FIG. 2 is a perspective view of a second preferred embodiment of the present invention.

FIG. 3 is a perspective view of a third preferred embodiment of the present invention.

FIG. 4 is another perspective view of the third preferred embodiment of the present invention.

### DETAILED DESCRIPTION OF PREFERRED EMBODIMENTS

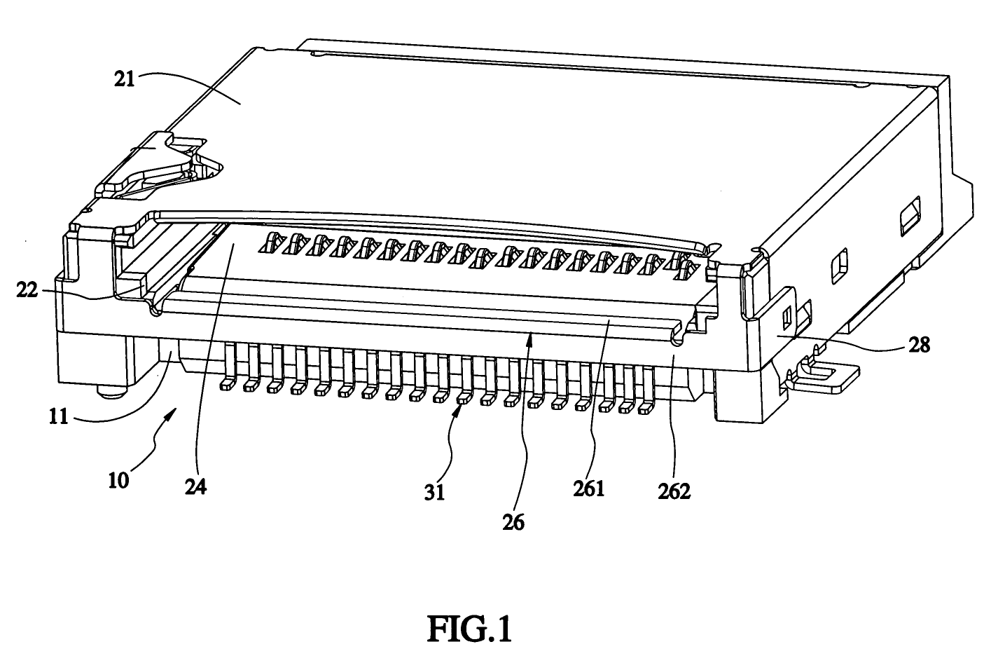

Referring to FIG. 1, an antistatic card connector 10 in accordance with a first preferred embodiment of the present invention is composed of a base frame 11, a cover shell 21, a grounding member 26, and a plurality of terminals 31.

The base frame 11 is made of insulative material.

The cover shell 21 is made of electrically conductive material and covered on the base frame 11. An opening 22 is formed at a front side of the combination of the cover shell 21 and the base frame 11. At least one card chamber 24 is formed inside the combination of the cover shell 21 and the base frame 11 for receiving an electronic card (not shown).

The terminals 31 are mounted to the base 11 and located inside the card chamber 24.

The grounding member 26 is located at a front edge of the base frame 11, extending transversally along a front side of the base frame 11. The grounding member 26 is made of electrically conductive material and located below the opening 22. The grounding member 26 includes a top face 261 and a front face 262, having an L-shaped cross-section. The top face 261 and the front face 262 cover upper and lower sides of the front edge of the base frame 11 respectively. Among the terminals 31, some of them each have one end reaching the front edge of the base frame 11 and located below the grounding member 26 spaced therefrom. Two extension parts 28 reach rearward from left and right ends of the grounding member 26 respectively, for connection with external wires (not shown). Because the two extension parts 28 are located at two ends of the grounding member 26, the static of the grounding member 26 can be directly conducted outward. In this embodiment, the grounding member 26 and the cover shell 21 are formed in one piece.

When the electronic card is inserted into the card connector 10, whether the card touches the cover shell 21 or the grounding member 26, the static of the card can be conducted for grounding because each of the cover shell 21 and grounding member 26 is made of the electrically conductive material. In this way, the static of the card can be effectively prevented from damaging one or more external electronic components or apparatuses connected with the card connector 10. Besides, the terminals 31 are spaced from the grounding member 26 for a predetermined interval, such that the terminals 31 are protected by the grounding member 31 from contact with the inserted electronic card, further preventing the static of the electronic card from conduction to the terminals 31.

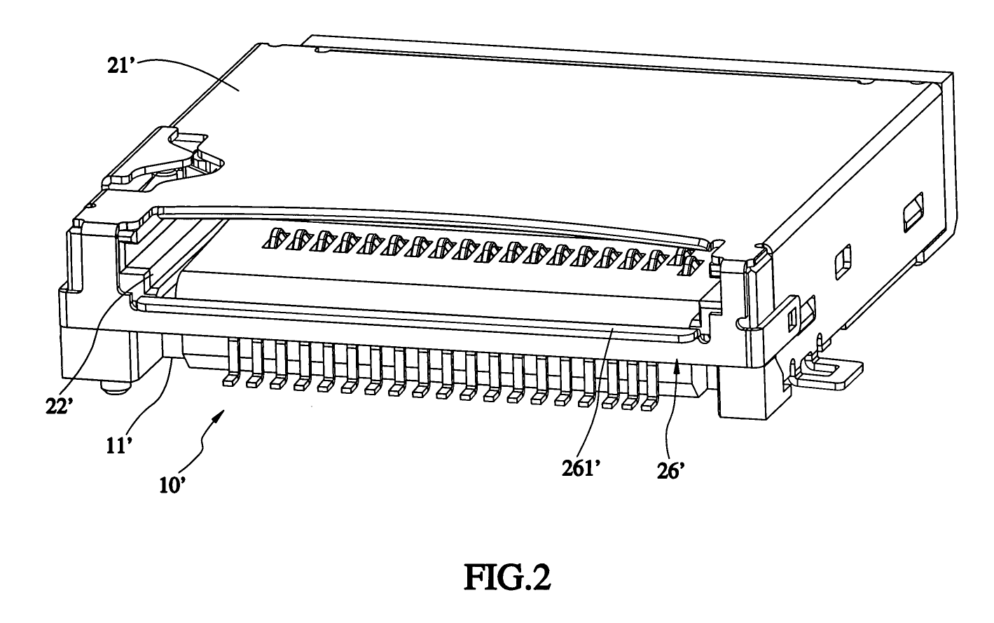

Referring to FIG. 2, an antistatic card connector 10′ in accordance with a second preferred embodiment of the present invention is similar to the first embodiment, having the following difference. The grounding member 26′ reaches outward from a front side of the base frame 11′ for a predetermined length to become the front face 261′. When the card is inserted, before the card enters the opening 22′, the card first contacts the grounding member 26′ for grounding the static thereof. Because the other structures and operation manners are identical to those of the first embodiment, no more recitation is necessary.

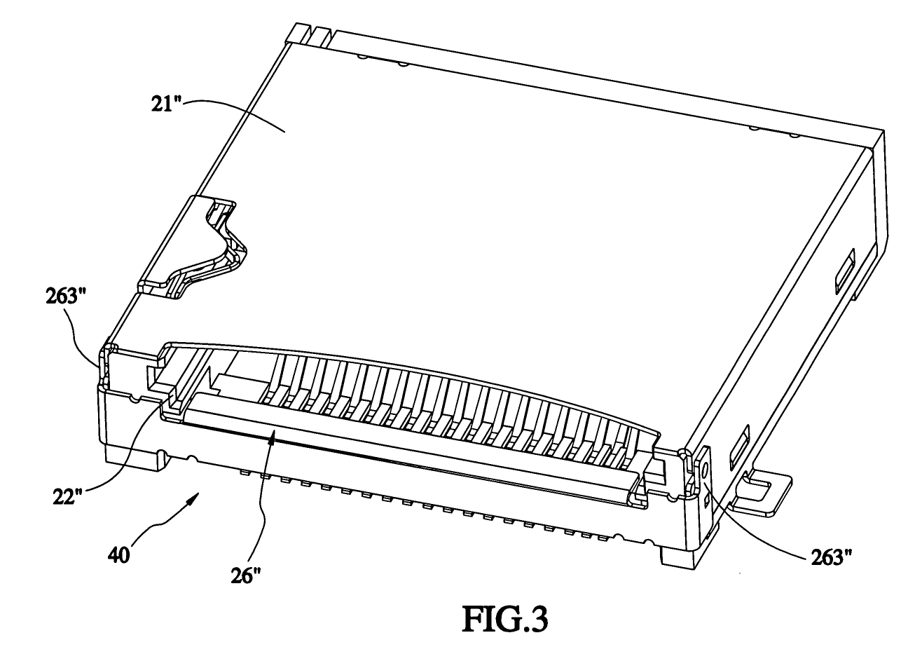

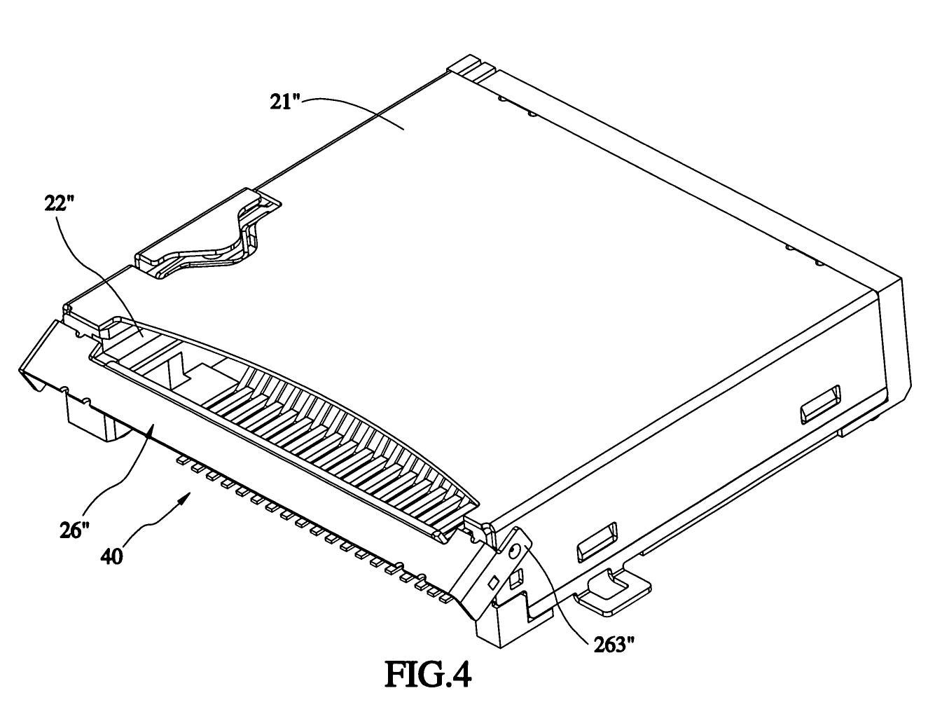

Referring to FIGS. 3-4, an antistatic card connector 40 in accordance with a third preferred embodiment of the present invention is similar to the first embodiment, having the following difference. The grounding member 26″ is independent from the cover shell 21″ and they are connected with each other. Two connection parts 263″ each reach upward from one of two sides of the grounding member 26″ and each are connected with one of two sides of the cover shell 21″. In this embodiment, the connection parts 263″ are pivoted to the cover shell 21″. In this way, the cover shell 21″ and grounding member 26″ located above and below the opening 22″ respectively can ground the static to protect the terminals from damage of the static. In addition, the connection parts 263″ can also work like the extension parts 28 of the first embodiment for convenient connection with the external wires and for effective grounding. Because the other operation manners are identical to those of the first embodiment, no more recitation is necessary.

As know from the aforementioned three embodiments, the present invention is characterized in that the grounding member 26 is mounted below the opening 22 and the cover shell 21 is mounted above the opening 22 and such structure constitutes a complete grounding protocol by which the inserted card will definitely contact the grounding member 26 or the cover shell 21 to ground the static thereof. In this way, the static will not be conducted to the terminals and thus the electronic apparatus or components can be further protected.

Although the present invention has been described with respect to specific preferred embodiments thereof, it is no way limited to the details of the illustrated structures but changes and modifications may be made within the scope of the appended claims.

What is claimed is:

1. An antistatic card connector comprising:
a base frame made of insulative material;
a cover shell made of electrically conductive material and covered on said base frame, wherein an opening is formed at a front end of the combination of said base frame and said cover shell, and at least one card chamber is formed inside the combination of said base frame and said cover shell for receiving a card;
a plurality of terminals mounted to said base frame and located inside said card chamber; and
a grounding member located at a front edge of said base frame and extending transversally along a front side of said base frame, said grounding member being made of electrically conductive material and located below said opening.

2. The antistatic card connector as defined in claim 1, wherein said grounding member comprises a top face and a front face, said top facing covering a top side of the front edge of said base frame, said front face covering a front side of the front edge of said base frame.

3. The antistatic card connector as defined in claim 1, wherein some of said terminals each comprise an end reaching the front edge of said base frame and located below said grounding member and spaced from said grounding member.

4. The antistatic card connector as defined in claim 1, wherein said grounding member and said cover shell are formed in one piece.

5. The antistatic card connector as defined in claim 1, wherein said grounding member reaches outward from the front edge of said base frame.

6. The antistatic card connector as defined in claim 1, wherein said grounding member and said cover shell are connected with and independent from each other.

7. The antistatic card connector as defined in claim 6, wherein there are two extension parts reaching upward from two ends of said grounding member, said two extension parts being connected with two sides of said cover shell respectively.

8. The antistatic card connector as defined in claim 1, wherein there are two extension parts reaching rearward from left and right ends of said grounding member respectively.
